(19) United States
(12) Patent Application Publication
(10) Pub. No.: US 2025/0300539 A1
(43) Pub. Date: Sep. 25, 2025

(54) ELECTRIC POWER GENERATION SET USING MAGNETIC FORCE WITH AN EFFICIENCY MORE THAN (2)

(71) Applicant: FFP Fuel Free Power General Trading L.L.C. (Company), Dubai (AE)

(72) Inventors: Hossam Aldin ALAKHDAR, Sharjah (AE); Ghassan BITAR, Sharjah (AE)

(73) Assignee: FFP Fuel Free Power General Trading L.L.C. (Company), Dubai (AE)

(21) Appl. No.: 18/813,315

(22) Filed: Aug. 23, 2024

(30) Foreign Application Priority Data
Mar. 19, 2024 (AE) 00660/2024

(51) Int. Cl. H02K 41/03

(52) U.S. Cl. CPC H02K 41/031

(57) ABSTRACT

Provided is a magnetic generator set including an axial impulse motor with an efficiency of more than (2) based on the conversion of magnetic force into motive force for electric power generation.

### BACKGROUND OF THE INVENTION

More than 75% of the world's electricity generation sources depend primarily on fossil fuels such as fuel oil, natural gas, and coal. This leads to high levels of environmental pollution and increased carbon (CO2) emissions.
The world needs more electricity urgently and rapidly, which will lead to increased pollution and carbon emissions. Therefore, there was an urgent need to change the sources of electricity in the world.
Solar power plants and wind turbine plants have started to increase, and according to global studies issued by the International Energy Agency:
The global demand for electricity is estimated to increase by 8% per year.
There are still one billion people in the world who do not have access to electricity, and 300 million of them live in India.
The amount of electricity generated from renewable energy worldwide increased by 6% in 2022, while the energy generated from coal increased by 9%.
70% of industrial power depends on natural gas, which has seen a 450% increase in prices in the past 12 months.
Carbon (CO2) emissions from energy generation sources must be reduced urgently to avoid the catastrophic effects of climate change.

Therefore, we studied and manufactured a new innovation for the first prototype of a generator set that replaces any type of traditional generator set that uses fossil fuels.
This is done by using magnetic force (Repelling) and converting the magnetic force into motive force that is associated with an advanced Alternator to produce magnetic Generating set.
We have also designed and developed an integrated generation system with a load distribution structure for electric energy according to organized arrangements using permanent magnets and electromagnetic coils.
The device (system) can operate independently and maintain its rotational speed (RPM) according to the energy drawn from it according to a precise control system. The permanent magnet retains its energy for hundreds of years, as the process of magnetic decay is very small during the life of the machine at a rate of 1% every 10 years.

### FFP (Fuel Free Power) Company:

We are a company working in the field of innovation and technology that strives to improve the world through magnetic energy and science.
The company's scientific research team started working on the project idea in 2020.
The company was established in 2023 and began working on developing a clean and safe energy source to address the shortage of electricity and environmental challenges in order to raise global living standards.
Our company seeks to be a global leader in the field of new and renewable energy technologies that provide sustainable and safe energy that preserves the environment and human health at the same time.
Our work is based on respect for scientific principles and physical laws, especially the law of conservation of energy.
We have faced many challenges and accepted them because magnetic technology is safer, more economical, and more adaptable to the environment.
Our project was designed with a focus on the future. Our goal was to change the process of electricity generation, which relies on outdated concepts. We dared to move forward to end the cycle of destruction and environmental impact caused by current energy sources.

### Features of Magnetism in Clean Energy Generation

### Sustainability First:

Magnetic-based electricity generation is a sustainable process by nature, unlike fossil fuels that deplete over time. Magnets retain their strength for hundreds of years. This means that once a magnetic generator is started, it provides a reliable and stable source of energy for the long term without harming the environment.

### Minimal Environmental Impact:

When it comes to clean energy, reducing the environmental footprint is critical. Magnetic generator sets do not produce any emissions or pollutants, greenhouse gases, and they operate silently without the need for combustion. This makes them an ideal choice for individuals and countries concerned about the environment.

### Cost-Effective Energy Production:

Magnetic generator sets are not only clean but also cost-effective. Once the initial investment is made and the generator set is built, operating costs will be minimal. This makes magnetism an attractive option for both residential, commercial, and industrial applications, reducing energy bills while contributing to a green future.

### Clean Energy for Homes and Industries:

When magnetic generator sets find their way into homes and industries and provide a reliable source of clean energy, they will power appliances, heating and cooling systems, or even an entire factory. This is a sustainable and effective solution.

### Overcoming Challenges

While the Magnetic Revolution holds tremendous promise, it is important to acknowledge the challenges it faces. One of the main challenges is the need for more research and development to improve energy generation. Changes in infrastructure will also be necessary to seamlessly integrate magnetically generated energy into existing public networks.

### The Way Forward

We are on the cusp of a magnetic revolution in clean energy. It is clear that the possibilities are endless. Magnetic energy provides a sustainable, environmentally friendly, and cost-effective alternative to traditional energy sources in all areas, from transportation to daily energy needs. This means that magnetism is reshaping the way we think about energy. The path is clear: magnetism will play a major role in promoting a cleaner and greener future.

### Unleashing the Global Potential of Magnetic Energy:

Humanity is constantly striving to find sustainable and efficient energy sources. Among the various forms of renewable energy, our invention stands as a beacon of hope for a better future. It meets our energy needs without harming the environment. Let us delve deeper into the fascinating world of magnetism and explore its immense potential and the impact it can have on our lives.

### General Description of the Invention

It is a generating set consisting of a coupling an axial impulse motor based on the rotation of the wheel containing the magnets that are placed according to a specific and precise arrangement to form the rotor.

And a group of electromagnetic coils installed in a specific array and their positions are calculated to form a stator, within an interconnected and correct mechanical system consisting of an axis on which a rotation wheel is placed and side connecting rods where the axis is placed on rotational bearings.

Its operation is controlled according to a control system based on a microcontroller that contains the operating program, The inputs are magnetic field sensors and the outputs are operating transistors that give the impulse pulse to each coil at the required moment, which leads to the formation of a rotational movement at the appropriate speed to maintain the regulation of the rotation speed, according to the energy that is drawn from the alternator according to the control system. The previously mentioned motor is connected to the alternator. Through a gearbox to adapting the speed.

### Features of Our Invention

### Clean and Renewable Energy:

Magnetic energy is clean and renewable by nature and does not produce any pollution to the environment. This makes it a solution that can contribute to combating the global environmental crisis.
The device does not have any carbon (CO2) or radioactive emissions.
The device does not require any type of fuel and therefore does not require emission containment equipment and its high costs.
The device does not require complex and periodic maintenance like traditional stations.
The system can have a lifespan of up to 50 years.

Low Operating Costs: Once the magnetic generator set is completed and put into service, its operating costs are minimal. It does not require any fuel supplies and minimal maintenance. The magnets used also have a long life, which reduces maintenance costs and increases operational capacity. This is an ideal option for both developed and developing countries.

Reliable Source of Energy: Magnetic generator sets are highly reliable and can operate continuously, providing a stable source of electricity. This reliability is critical for industries, homes, and communities that rely on a stable source of energy.

Scalability: The scalability of magnetic generator sets is an important feature. We can expand the power generation capacity by adding more magnetic units. This scalability allows individuals and businesses to design their own energy solutions according to their specific needs.

Noise-Free Operation: Unlike some energy sources such as wind turbines or diesel generators, magnetic generator sets operate silently. The absence of noise pollution is particularly beneficial in populated areas or locations with noise regulations.

No Geographic Restrictions: Magnetic generator sets are not bound by geographic restrictions and can be used effectively in different areas around the world. This makes them a real energy solution no matter how remote the location.

### Global Applications of Our Invention

### 1. Industrial Sector:

Industries can benefit greatly from our invention. Factories that require a stable and reliable source of energy, especially when their power supply is through electrical networks that are prone to frequent outages, can reduce operating costs and environmental impact by using magnetic generators.

### 2. Remote and Off-Grid Areas:

Magnetic generators can change the poor living conditions for remote and off-grid areas or those that suffer from long power outages or grid failures. This provides these communities with access to clean and sustainable energy, improving their living conditions and opening the way for economic activities in their areas.

Magnetic generator sets hold great promise for a world where we can meet our electricity needs without harming the environment. This is all just an example.

### BRIEF DESCRIPTION OF DRAWINGS

FIGS. 1 through 3 illustrate operations and structure of example embodiments of the present disclosure.

### DETAILED DESCRIPTION

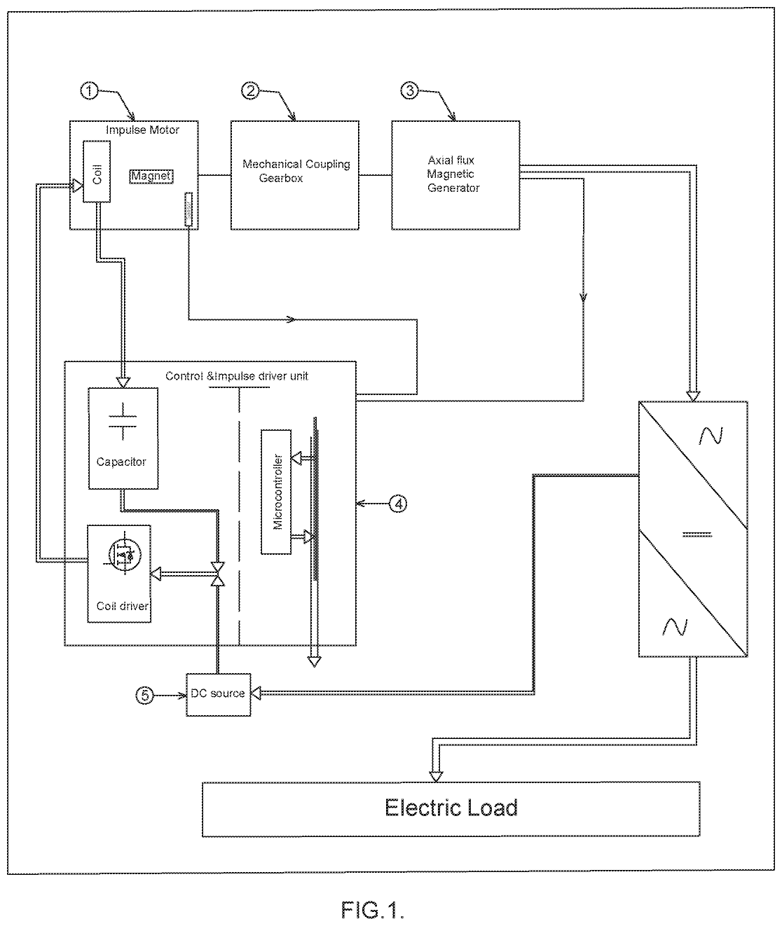

The magnetic generator set presented as a model includes the following elements as shown in the single diagram FIG. 1.:
1—Impulse motor
2—Mechanical coupling (Gearbox).
3—Generator: Axial flux magnetic Generator.
4—Control unit: Control & impulse driver unit.
5—Power supply unit: DC source.
   1-Impulse motor:

Impulse motor: It works on the repulsion between a group of permanent magnets, and a group of coils that form electromagnets distributed over three phases and driven by unilateral pulses generated by the control and driving system.

Permanent magnets are positioned axially near the periphery of a disc of non-magnetic material fixed on an axis supported at both ends by bearings fixed to a sturdy metal frame. The coils are positioned on a holder so that the surface of the coils faces the north pole of the magnets. The coils are fed from a DC power source with unilateral pulses generated by a control system that determines the pulse specifications. Through this process, a north pole opposite the north pole of the permanent magnets is formed in one third of the number of coils for each pulse, thus feeding all coils in three phases.

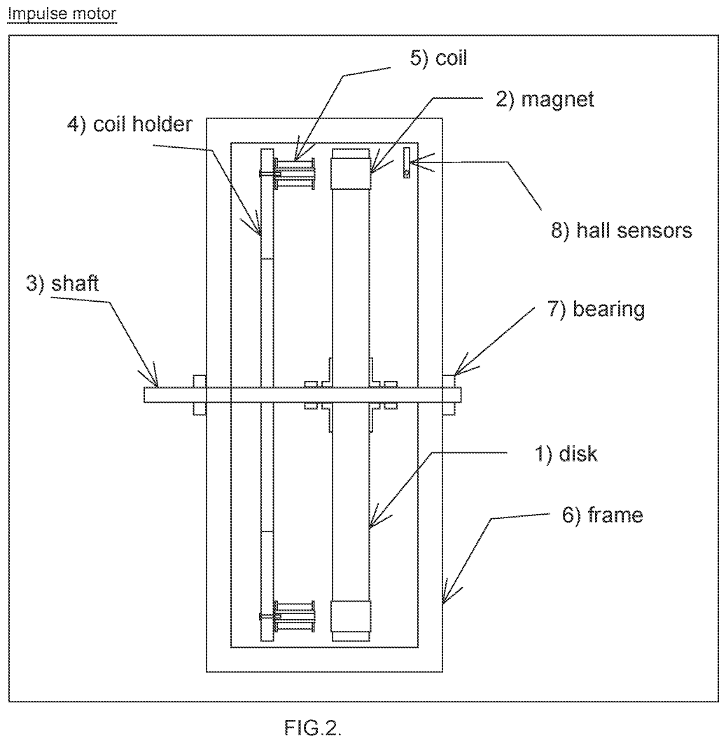

The main parts of the impulse motor are as follows and are shown in the FIG. 2.:

### Rotor:

1) Non-magnetic disc: as plastic (PA66/HDPE).
2) Permanent magnets:
   Cylinder Type (N52).
   Diameter 50 mm.
   Length 60 mm
3) Steel shaft: SS shaft 28 mm

### Stator:

4) Coil holder: non-magnetic sheet.
5) Electromagnet Coil.
6) Metal frame.
7) Bering.
8) Hall sensor.

### 2—Mechanical Coupling Unit (Gearbox):

The gearbox is used in the process of connecting the impulse motor and the generator, as it matches the speed of the impulse motor with the speed requirements of the generator.

### 3—Generator:

Axial Flux Coreless Generator are:
Starting torque: Very low, less than 0.03 N/m.
Efficiency: Very high, due to the air core and the special configuration of the coils, which gives very low mechanical resistance.
Magnets: Neodymium magnets are used.
Higher Reliability: special structure make it bigger ratio of power to volume, power to weight and have long life of 8 times longer than traditional generator.
Generation efficiency: Very high, even at low rotational speed.
Thermal cooling: Very high, due to the special aluminum alloy of the Alternator body and the special internal structure.
Rated power: 2 kilowatts.
Rated rotational speed: 120 revolutions per minute.
Output voltage: 380 Vac.
Number of poles: 32.
Start torque: Less than 0.03 N/m.
Outer diameter: 550 mm.
Weight: 75 kg.
Rated current: 3 A.
Output frequency: 32 Hz.
Efficiency: Greater than 92%.
Insulating resistance: 100 Mohm Min (501V DC).
Rated Torque: 173 N/m

| Rated Power | 2 | KW |
|---|---|---|
| Rated Rotate Speed | 120 | RPM |
| Rated Voltage | 380 | Vac |
| Rated Current | 3 | A |
| Frequency | 32.0 | Hz |
| Poles | 32 | |
| Efficiency | >92% | |
| Insulating Resistance | 100 Mohm Min(501 V DC) | |
| Start Torque | <0.03 | N/M |
| Rated Torque | 173 | N/M |
| Generator Diameter | 550 | mm |
| Weight | 75 | Kg |

| NO. | RPM | Power(W) | Voltage (V) |
|---|---|---|---|
| 1 | 0 | 0 | 0 |
| 2 | 15 | 100 | 48 |
| 3 | 30 | 250 | 95 |
| 4 | 45 | 460 | 143 |
| 5 | 60 | 750 | 190 |
| 6 | 75 | 1100 | 238 |
| 7 | 90 | 1440 | 285 |
| 8 | 105 | 1760 | 333 |
| 9 | 120 | 2000 | 380 |
| 10 | 135 | 2250 | 428 |
| 11 | 150 | 2420 | 475 |

### 4—Electronic Control and Pulse Generation Unit:

This unit consists of the following elements:
Processing section (microcontroller) and peripheral units
It receives signals from the sensors, feedback signals, and sends control signals for the power transistors.
Power section:
The power section is responsible for generating the pulses that drive the coils.
It consists of:
   Power transistors
   Pick up capacitor, which is used to detect the reverse pulses generated by the coils and stores their charge

### 5—Variable Power Supply Unit:

The control and pulse generation unit is supplied by a variable DC source.

### Outline of the Invention

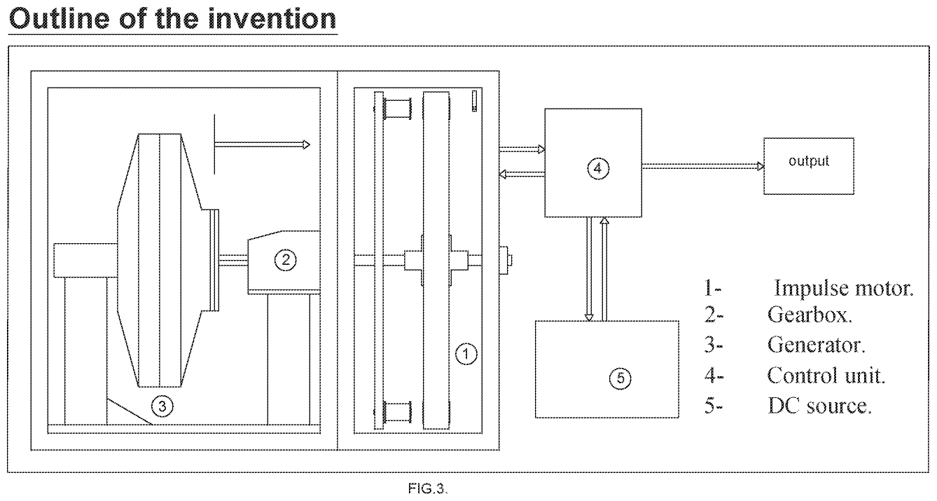

The drawing in FIG. 3. is showing the main parts of the machine
1—Impulse motor.
2—Gearbox.
3—Generator.
4—Control unit.
5—DC source.

1-9. (canceled)

10. Magnetic Generator Set consisting of an Impulse motor, Gearbox, Generator, Control unit, and DC source.

11. Control Unit Function, wherein:
a motor is operated in three phases in the presented model;
a rising edge of a coil charging pulse is used as the impulse pulse; and
a reverse pulse is recovered when the coil is discharged into a capacitor.

12. Control Software, designed according to the following algorithm:
Step 1: Initial drive pulse;
Step 2: Read the sensors array;
Step 3: Generate control signals for the power transistors to provide the impulse pulse for the drive coils;
Step 4: Read a sample of the output voltage;
Step 5: Compare the output voltage sample with a reference voltage;
Step 6: Calculate the rotational speed based on the previous comparison;
Step 7: Adjust the rotational speed to the desired speed;
Step 8: Return to step/2/.
